(19) United States
(12) Patent Application Publication
(10) Pub. No.: US 2026/0087316 A1
(43) Pub. Date: Mar. 26, 2026

(54) UNSUPERVISED HETEROPHILIC EDGE GRAPH ANALYSIS MODEL AND ANALYSIS METHOD USING SAME

(71) Applicant: UNIVERSITY OF SEOUL INDUSTRY COOPERATION FOUNDATION, Seoul (KR)

(72) Inventors: Heasoo HWANG, Seoul (KR); Seok Hwi CHOI, Seoul (KR)

(21) Appl. No.: 19/337,822

(22) Filed: Sep. 23, 2025

(30) Foreign Application Priority Data
Sep. 26, 2024 (KR) 10-2024-0130756

(51) Int. Cl. G06N 3/0455; G06F 16/901; G06N 3/088

(52) U.S. Cl. CPC G06N 3/0455; G06F 16/9024; G06N 3/088

(57) ABSTRACT

The present application relates to an unsupervised heterophilic edge graph analysis model using an edge discriminator and a multi-channel encoder, and a learning method using the same, and generates a feature information-based representation, a connection information-based representation and a weighted graph-based representation. Then, these representations are combined to generate a final node representation vector, and the consistency of the representation is enhanced through contrastive learning. Compared with the conventional single channel model, the node representation power is increased, which leads to excellent node classification accuracy. In addition, the model of the present application may be applied to unlabeled datasets through unsupervised learning, and particularly exhibits excellent performance on heterophilic edge graph. The present application may be applied to data analysis with complex relationships in the fields such as social network analysis, recommendation systems, and bioinformatics, and may be utilized for various graph-based tasks such as anomaly detection and link prediction.

### DESCRIPTION REGARDING GOVERNMENT-SPONSORED RESEARCH OF DEVELOPMENT

This study was supported by the Individual Basic Research Program of the Ministry of Science and ICT of the Republic of Korea, under the supervision of the University of Seoul Industry-University Cooperation Foundation (Project Title: Adaptive Self-Supervised Learning Framework for Graph Deep Learning, Project Number: 1711182215).

### CROSS-REFERENCE TO RELATED APPLICATION

The present application claims priority to Korean Patent Application No. 10-2024-0130756, filed on Sep. 26, 2024, the entire contents of which are incorporated herein by reference.

### TECHNICAL FIELD

The present application relates to graph data analysis technology, and more particularly, to a heterophilic edge graph analysis model using unsupervised learning and an analysis method using the same. In particular, the present application relates to a technique for utilizing a multi-channel encoder to effectively process and integrate feature information of node and connection information, and homophily and heterophily information of edges to generate representation vectors of nodes in a graph, thereby performing node classification and other analysis tasks on an unlabeled heterophilic edge graph.

### BACKGROUND ART

Structural data of graph is effectively used to represent complex relationships and interactions, and plays an important role in various fields such as social networks, biological networks, and recommendation systems. Graph Neural Networks (GNNs) are widely used techniques for analyzing and learning such graph data.

Traditional graph analysis methods have been developed primarily based on a homophily assumption. This is an assumption that the connected nodes have similar characteristics. However, many graphs in the real world have heterophilic characteristics, so that connected nodes often have different characteristics.

Methods for effectively analyzing such heterophilic edge graph have been proposed, but most of these methods rely on supervised learning. This is limited in that a label is required for learning data, and there is a problem in that it is difficult to apply to a large-scale unlabeled datasets.

In addition, conventional graph representation learning methods have difficulty in simultaneously considering both the feature information of node and the structural information of graph. In particular, in a heterophilic edge graph, it is an important task to utilize these two types of information in an appropriate balance.

Therefore, there is a need to develop an unsupervised learning method capable of effectively integrating and analyzing the feature information of node and structural information of graph in an unlabeled heterophilic edge graph.

### PRIOR ART DOCUMENTS

Patent Document 1: US 2024/0037401 A1

### DISCLOSURE OF THE INVENTION

### Problems to be Solved

Accordingly, the technical problem to be solved by the present application aims to provide an unsupervised learning model capable of effectively classifying and analyzing nodes in an unlabeled heterophilic edge graph. Specifically, the present application aims to propose a multi-channel encoder structure capable of considering the feature information of node, connection information of graph, and homophily and heterophily information of edges in a balanced manner. An object of the present application seeks to present a method for accurately discriminating the characteristics of edges in a heterophilic edge graph, and effectively utilizing such characteristics in graph representation learning. The present application proposes a contrastive learning method for enhancing quality of a generated node representation vector. The present application seeks to develop a scalable model applicable to heterophilic edge graphs of various types and scales. The present application seeks to present a model that demonstrates superior performance on heterophilic edge graphs compared to conventional homophily-based graph analysis methods. The present application aims to provide a graph analysis method that may be practically utilized in various fields such as social network analysis, recommendation system, and bioinformatics.

### Means for Solving the Problem

According to an embodiment for achieving the objective of the present application, an unsupervised heterophilic edge graph analysis model may include: an input unit configured to receive feature information and connection information for nodes in a heterophilic edge graph; an edge discriminator configured to calculate a homophily weight and a heterophily weight for each edge of the graph; a multi-channel encoder including: a first channel configured to process the feature information, a second channel configured to process the connection information, and a third channel configured to generate and process a weighted graph using the homophily weight and the heterophily weight; an output unit configured to output a representation vector for each node generated from the multi-channel encoder; and a classification unit configured to classify nodes of the graph using the output representation vectors.

In an embodiment, the multi-channel encoder may further include a combining unit configured to generate a final representation vector by combining intermediate representation vectors respectively generated from the first channel, the second channel, and the third channel.

In an embodiment, the combining unit may combine the intermediate representation vectors through linear combination using a weight matrix.

In an embodiment, the model may further include a contrastive learning unit configured to perform contrastive learning on the generated representation vectors.

According to another embodiment for achieving the objective of the present application, an unsupervised heterophilic edge graph analysis method may include: receiving feature information and connection information for nodes in a heterophilic edge graph; calculating a homophily weight and a heterophily weight for each edge of the graph by using an edge discriminator; generating a representation vector for each node by using a multi-channel encoder including a first channel configured to process the feature information, a second channel configured to process the connection information, and a third channel configured to generate and process a weighted graph by using the homophily weight and the heterophily weight; outputting the generated representation vectors; and classifying nodes of the graph by using the output representation vectors.

In an embodiment, the method may further include: combining intermediate representation vectors respectively generated from the first channel, the second channel, and the third channel, to generate a final representation vector.

In an embodiment, the combining of the intermediate representation vectors may be performed through linear combination using a weight matrix.

In an embodiment, the method may further include performing contrastive learning on the generated representation vectors.

In an embodiment, the contrastive learning may be performed such that representation vectors of the same node from different perspectives become similar.

In an embodiment, the present disclosure may be implemented as a computer-readable recording medium having recorded thereon a program for causing a computer to execute the unsupervised heterophilic edge graph analysis method.

### Effects of the Invention

The present application enables effective classification and analysis of nodes even in an unlabeled heterophilic edge graph, thereby greatly reducing the cost and time required for data labeling. By considering the feature information of node, connection information of graph, and homophily information and heterophily information of edges in a balanced manner through the multi-channel encoder structure, more accurate and expressive node representation vectors may be generated. By accurately capturing the characteristics of the heterophilic edge graph through the edge discriminator and utilizing such characteristics for learning, it is possible to achieve better performance in the heterophilic edge graph than conventional homophily-based models. By enhancing the quality of the generated node representation vector by applying the contrastive learning method, high accuracy may be obtained in downstream tasks such as node classification. The model of the present application has scalability applicable to heterophilic edge graphs of various types and scales, and may be widely utilized for complex network data in the real world. The method of the present application may be practically utilized in various fields such as social network analysis, recommendation system, and bioinformatics, thereby contributing to the development of related industries. By adopting the unsupervised learning method, the model may quickly adapt and be applied to new data or domains, thereby significantly enhancing its versatility and practical usability. The model of the present application enables more accurate data analysis and decision-making by enhancing node classification accuracy in heterophilic edge graph compared to conventional methods.

The effects of the present application are not limited to the above-mentioned effects, and other effects that are not mentioned will be clearly understood by those skilled in the art from the description of the claims.

### BRIEF DESCRIPTION OF THE DRAWINGS

FIG. 1 is a schematic diagram of an unsupervised heterophilic edge graph analysis model, according to an embodiment of the present application.

FIG. 2 is a flowchart of an unsupervised heterophilic edge graph analysis method, according to an embodiment of the present application.

FIG. 3 is a schematic diagram of an unsupervised heterophilic edge graph analysis model configured with an edge discriminator and a contrastive learning unit, according to an embodiment of the present application.

FIG. 4 is a diagram illustrating a structure of a multi-channel encoder, according to an embodiment of the present application.

FIG. 5 is a diagram illustrating a process in which intermediate representation vectors H₁, H₂, and H₃ generated from three channels of the multi-channel encoder structure are integrated in a combining unit to generate a final representation vector Hfin, according to an embodiment of the present application.

FIG. 6 is a table showing dataset statistics for learning the unsupervised heterophilic edge graph analysis model, according to an embodiment of the present application.

FIG. 7 is a table showing a result of comparing node classification accuracy between the unsupervised heterophilic edge graph analysis model and an conventional model (GREET) on six heterophilic edge graph benchmark datasets, according to an embodiment of the present application.

FIG. 8 is a table comparing edge property prediction accuracy and vertex classification accuracy according to the change in the number of positive samples, between the unsupervised heterophilic edge graph analysis model and the conventional model (GREET), according to an embodiment of the present application.

FIG. 9 is a table showing vertex classification accuracy result of the unsupervised heterophilic edge graph analysis model in consideration of channel importance, according to an embodiment of the present application.

FIG. 10 is a table showing importance results of each representation based on a weighted graph-based representation of the unsupervised heterophilic edge graph analysis model, according to an embodiment of the present application.

### DETAILED DESCRIPTION FOR CARRYING OUT THE INVENTION

Hereinafter, some embodiments of the present application will be described in detail with reference to illustrative drawings. In adding reference numerals to components in each drawing, the same components may have the same numerals as much as possible even if they are displayed on different drawings. In addition, in describing the present embodiments, when it is determined that a specific description of a related known configuration or function may obscure the gist of the present technical idea, a detailed description thereof may be omitted.

When “comprise,” “have,” “consist of” and the like mentioned in this specification are used, other parts may be added unless “only” is used. The singular forms “a,” “an,” and “the” may include plural referents unless the context clearly dictates otherwise.

In addition, in describing the components of the present application, terms such as first, second, A, B, (a), and (b) may be used. Unless otherwise specified, such terms are merely used to distinguish one component from other components, and the nature, sequence, order, number, or the like of the components is not limited by the terms.

In the present application, “learning” or “learning” is a term that refers to performing machine learning through computing according to a procedure.

It is intended that terms such as “unit,” “module,” “apparatus,” or “system” in the present application may refer to a combination of hardware as well as software driven by that hardware. For example, the hardware may be a data processing device including a Central Processing Unit (CPU), a Graphic Processing Unit (GPU), or another processor. Software may also refer to a running process, an object, an executable, a thread of execution, a program, etc.

### Definitions of Term

A graph is a data structure composed of a node and an edge, and is used to represent relationships between objects.

A node is a basic element constituting a graph, and represents an individual object or a data point.

An edge is a component of a graph representing connections between nodes.

Homophily refers to the tendency of connected nodes in a graph to have similar characteristics.

Heterophily refers to the tendency of connected nodes in a graph to have different characteristics.

A heterophilic edge graph means a graph mainly composed of edges with high heterophily.

Unsupervised learning refers to a machine learning method that learn a model using unlabeled data.

A node representation is a result of mapping each node of a graph to a vector space, and includes characteristics of the node and structural information of the graph.

A multi-channel encoder is a neural network structure that processes input data through several parallel processing paths (channels).

An edge discriminator is a model component for discriminating whether an edge of a graph is homophilic or heterophilic.

Contrastive learning refers to a method of learning to represent similar data pairs closely and different data pairs far apart.

A weighted graph refers to a graph in which a weight is assigned to an edge, and a homophily/heterophily weight is used in the present application.

### Model Structure

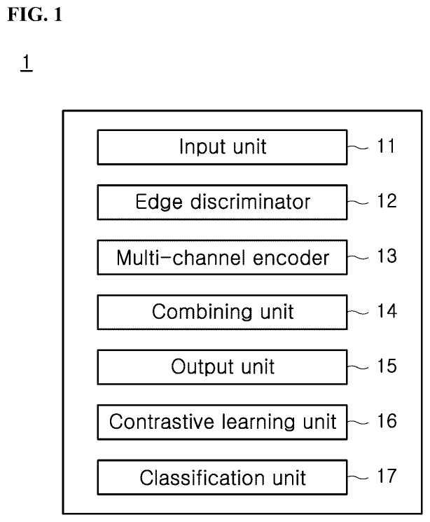

FIG. 1 is a schematic diagram of an unsupervised heterophilic edge graph analysis model, according to an embodiment of the present application.

Referring to FIG. 1, the unsupervised heterophilic edge graph analysis model 1 of the present application is composed of an input unit 11, an edge discriminator 12, a multi-channel encoder 13, a combining unit 14, an output unit 15, a contrastive learning unit 16, and a classification unit 17.

The input unit 11 serves to receive information of the heterophilic edge graph to be analyzed. Specifically, the input unit 11 receives, as input, feature information for nodes of the graph and connection information between the nodes. The feature information may be data in the form of a vector representing a unique attribute of each node, and the connection information may be provided in the form of an adjacency matrix representing the structure of the graph. Due to the characteristics of the heterophilic edge graph, the input unit 11 is designed to be able to capture such complex relationships, since the characteristics between the connected nodes may be different.

The edge discriminator 12 calculates a homophily weight and a heterophily weight for each edge of an input graph. This process is an important step in quantifying the characteristics of each connection in the graph. The homophily weight indicates how similar the characteristics of two connected nodes are, while heterophily weights indicate the opposite. The edge discriminator 12 calculates these weights by comprehensively considering the feature vectors of the node pairs and the structural information of the graph. This allows the model to more accurately understand the complex relationships within the graph.

The multi-channel encoder 13 is a core component of the present model and is composed of three parallel channels. Each channel processes different aspects of the graph independently to generate an intermediate representation vector. The first channel processes feature information of node. This channel learns the unique attributes of each node to create a node-level representation. The second channel processes the connection information of the graph. This channel learns the structural characteristics of the graph to represent the relationships between the nodes. The third channel processes the weighted graph generated from the edge discriminator. This channel reflects the homophily and heterophily information to learn the complex relationships of the graph. Each channel converts input information into a high-dimensional representation vector using the neural network structure such as a multilayer perceptron (MLP).

The combining unit 14 integrates the three intermediate representation vectors generated from the multi-channel encoder 13 to generate a final representation vector for each node. In this process, the combining unit 14 may use an attention mechanism that dynamically adjusts the importance of the output of each channel. The attention mechanism assigns a weight to the output of each channel, giving greater importance to the most relevant information according to the characteristics of the current node. This allows the model to generate an optimized representation per node.

The output unit 15 outputs the final node representation vector generated from the combining unit 14. The representation vector compactly contains complex information such as characteristic of each node, its position in the graph, and its relationships with neighboring nodes.

The contrastive learning unit 16 performs contrastive learning on the output representation vectors. The contrastive learning is a process in which the representations of similar nodes are adjusted to be closer, while those of dissimilar nodes are adjusted to be farther apart. In this process, the model configures a positive pair and a negative pair, and optimizes a loss function that adjusts a distance therebetween. For example, nodes belonging to the same class or nodes at structurally similar positions may be set as a positive pair, while nodes that do not meet such conditions may be set as a negative pair. Through such contrastive learning, the model may better capture the global structure and local characteristics of the graph, and as a result, the quality of the node representation is enhanced.

Finally, the classification unit 17 classifies the nodes of the graph using the final representation vector subjected to the contrastive learning. This process is a step of predicting the characteristic or role of the node by utilizing a node representation that is a result of unsupervised learning. The classification unit 17 may be implemented in various forms from a simple linear classifier to a complex multilayer neural network. Because representations obtained through unsupervised learning are used, high classification performance may be achieved with only a small number of labeled data.

The unsupervised heterophilic edge graph analysis model 1 of the present application may effectively classify and analyze nodes even in the unlabeled heterophilic edge graph through such structure. The model considers both the structural characteristics of the graph and the unique features of nodes through the multi-channel encoder 13, and explicitly models heterophily through the edge discriminator 12. In addition, the contrastive learning unit 16 enhances the quality of the representations, which are utilized in classification to enable comprehensive and accurate graph analysis.

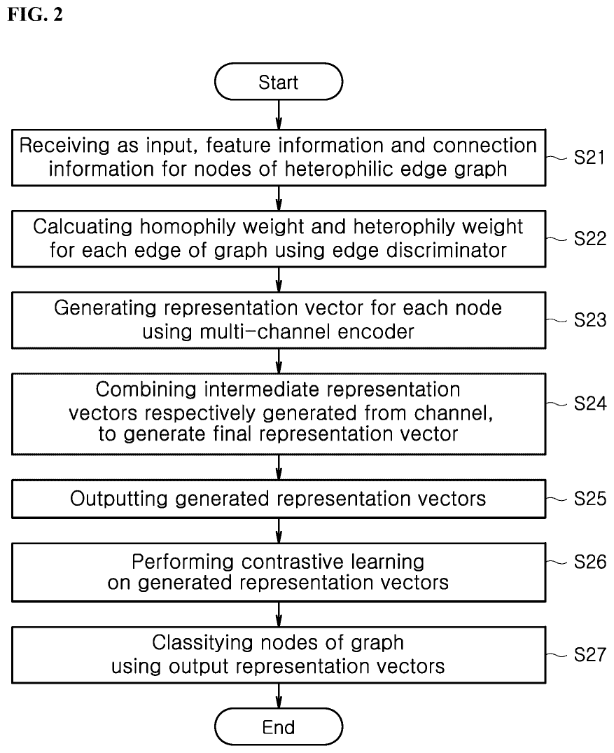

FIG. 2 is a flowchart of an unsupervised heterophilic edge graph analysis method, according to an embodiment of the present application.

Referring to FIG. 2, the method may be performed by each component of the unsupervised heterophilic edge graph analysis model 1 described in FIG. 1.

In step S21, feature information and connection information for nodes of the heterophilic edge graph are received as input through the input unit 11. This information includes the structure of the graph and the unique characteristics of each node.

In step S22, the edge discriminator 12 is used to calculate the homophily weight and the heterophily weight for each edge in the graph. This process quantifies the characteristics of each connection in the graph, which plays an important role in the subsequent analysis process.

In step S23, the multi-channel encoder 13 is used to generate a representation vector for each node. In this step, feature information of node, connection information of graph, and the weighted graph generated from the edge discriminator are respectively processed through three parallel channels. Each channel processes the input information independently to generate the intermediate representation vector.

In step S24, the intermediate representation vectors generated from each channel are combined through the combining unit 14 to generate the final representation vector. In this process, the attention mechanism that dynamically adjusts the importance of the output of each channel may be used.

In step S25, the generated representation vectors are output through the output unit 15. The representation vectors compactly contain complex information such as characteristics of each node, its position in the graph, and its relationships with neighboring nodes.

In step S26, contrastive learning is performed on the generated representation vectors through the contrastive learning unit 16. In this process, representations of similar nodes are adjusted to be closer, while representations of dissimilar nodes are adjusted to be farther apart, thereby enhancing the quality of the representations.

Finally, in step S27, the output representation vectors are used to classify the nodes of the graph through the classification unit 17. In this process, the characteristics or roles of node may be predicted by utilizing node representations that are the result of unsupervised learning.

For clarity of description, the above-described unsupervised heterophilic edge graph analysis method may be implemented by the unsupervised heterophilic edge graph analysis model, and may be described in more detail with the embodiments performed by the model.

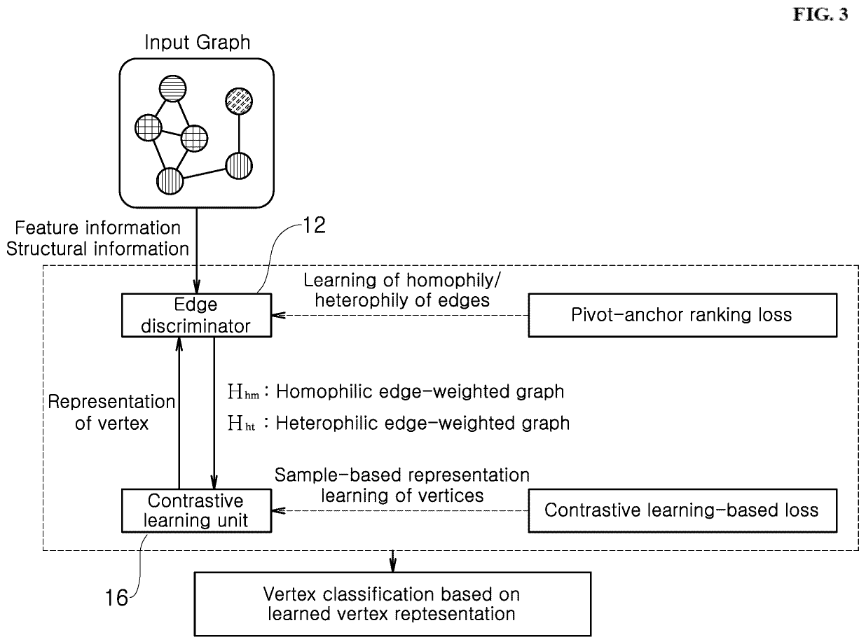

FIG. 3 is a schematic diagram of an unsupervised heterophilic edge graph analysis model configured with an edge discriminator and a contrastive learning unit, according to an embodiment of the present application.

Referring to FIG. 3, the input graph is shown at the top of FIG. 3. The graph is composed of nodes filled with various patterns and edges connecting them. The unique pattern of each node visually represents feature information of that node. The graph structure provides connection information between nodes.

Below the input graph are notations “feature information” and “structural information.” It represents two main types of information extracted from the input graph. The feature information refers to the unique attribute of each node, and the structural information refers to a connection pattern between nodes.

The edge discriminator 12 is a core component of the unsupervised heterophilic edge graph analysis model of the present application, and plays a role of discriminating between homophily and heterophily for each edge of the input graph. This process is performed by combining the “pivot-anchor ranking loss” method with graph representation learning, thereby accurately learning the characteristics of the edge. A specific operation principle is as follows:

Input: The edge discriminator receives, as input, the feature information of node (X) and the adjacency matrix (A) of the graph, and the representations of the nodes generated from the graph representation learner.

Calculating homophilic edge probability: the probability that an edge connects two nodes belonging to the same class, i.e., the homophilic edge probability, is calculated by using the input node representations.

Generating weighted graph: two weighted graphs are generated based on the calculated probability:

Homophilic edge-weighted graph (Hhm): High weights is given to edges with high homophily.

Heterophilic edge-weighted graph (Hht): High weights is given to edges with high heterophily.

Calculating pivot-anchor ranking loss: each node is set as a pivot, and other nodes are used as anchors to calculate the ranking loss. In this process: node pairs with high homophily are ranked higher in Hhm. Node pairs with high heterophily are ranked higher in Hht.

Optimization: The model parameters are adjusted in a direction that minimizes the calculated loss. This makes it possible to more accurately discriminate between homophily and heterophily of edges.

Output: Finally, the edge discriminator generates two weighted graphs Hhm and Hht, in which homophily weight and heterophily weight are respectively assigned to each edge.

Hhm and Hht thus generated are used as inputs of the contrastive learning unit 16. The contrastive learning unit 16 performs graph contrastive learning using the two augmented weighted graphs. In this process, a k-Nearest Neighbor (kNN) algorithm is used to extract positive sample and negative sample for contrastive learning. The learning is performed such that the representation of the target node becomes closer to that of a positive sample, and farther from that of a negative sample.

Next, the contrastive learning unit 16 improves the node representation using the “sampling-based vertex representation learning” method. This process serves to adjust the representation of similar nodes to be closer and the representations of dissimilar nodes to be farther apart.

Finally, a step of “vertex classification based on the extended vertex representation” is performed. In this step, the previously generated node representation is used to predict the class of each node. This is a step of applying a representation obtained by unsupervised learning to an actual task.

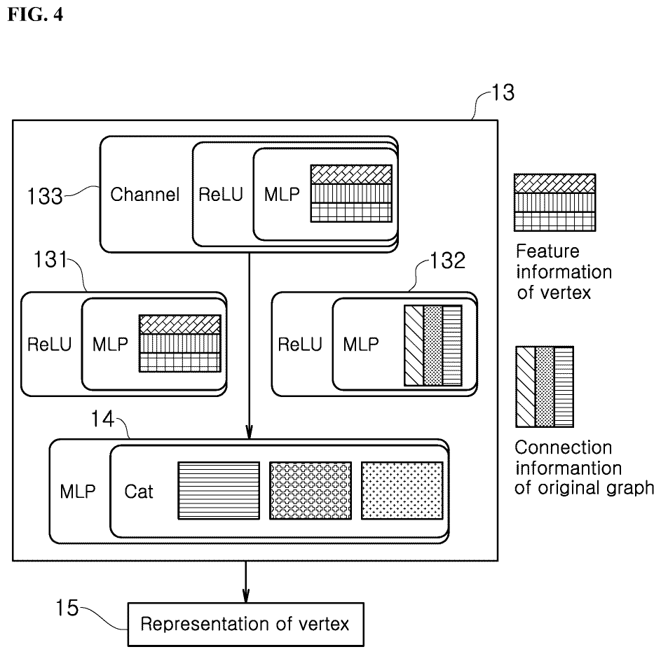

FIG. 4 is a diagram illustrating a structure of a multi-channel encoder, according to an embodiment of the present application.

Referring to FIG. 4, the multi-channel encoder 13 is largely composed of three channels:

First channel 131: This channel processes the feature information of the node. It is composed of a ReLU activation function and MLP (multilayer perceptron). “Feature information of the vertex” is received as input and processed.

Second channel 132: This channel processes the connection information of the graph. Similarly to the first channel, the channel is composed of ReLU and MLP. The “connection information of the original graph” is received as input and processed.

Third channel 133: This channel processes the weighted graph generated from the edge discriminator. Located at the top of the figure, the channel is composed of Channel, ReLU, and MLP. This channel also receives “connection information of the original graph” as input, but further utilizes weight information generated through the edge discriminator.

Each channel processes the input data independently to generate the intermediate representation vector. These intermediate representation vectors are delivered to the combining unit 14.

The combining unit 14 is composed of MLP and concatenation (Cat) operation in the bottom of the drawing. At this stage, the intermediate representation vectors generated from the three channels are integrated and processed. The combining unit applies appropriate weights to the output of each channel and concatenates them to produce the final node representation vector.

Finally, the generated final node representation vector is output as a “representation of the vertex” through the output unit 15. This representation compactly contains complex information such as the characteristics of each node, its position in the graph, and its relationships with neighboring nodes.

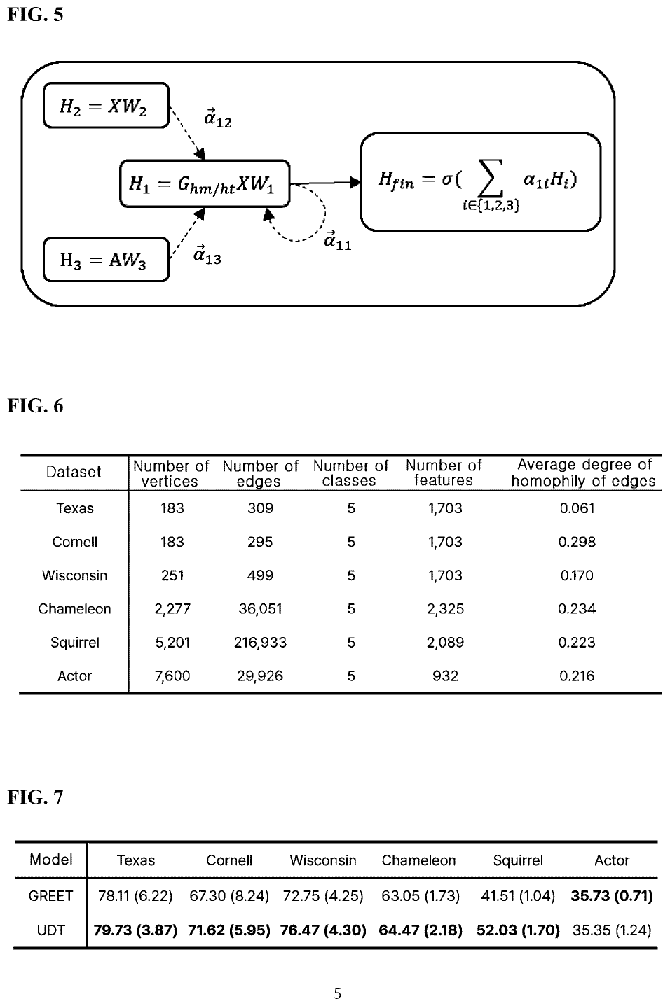

FIG. 5 is a diagram illustrating a process in which intermediate representation vectors H₁, H₂, and H₃ generated from three channels of the multi-channel encoder structure are integrated in a combining unit to generate a final representation vector Hfin, according to an embodiment of the present application.

Referring to FIG. 5, H₂ is an intermediate representation vector generated from the feature-based channel (first channel). H₂ is a feature-based representation, which is generated by multiplying the feature information X of node by the weight matrix W₂. H₁ is an intermediate representation vector generated from the weighted graph-based channel (third channel). H₁ is a weighted graph-based representation, and is generated by multiplying the homophily/heterophily weighted graph G_{hm/ht}, the feature information X of node, and the weight matrix W₁. H₃ is an intermediate representation vector generated from the connection-based channel (second channel). H₃ is a concatenation-based representation, which is generated by multiplying the adjacency matrix A of the original graph by the weight matrix W₃. These three intermediate representation vectors are combined using the channel importance parameter α_{1i}(i∈{1, 2, 3}). Each α_{1i} is a representation parameter for representation learning in that channel, and is a channel importance parameter for learning importance of the representation generated by each channel based on the weighted graph-based representation H₁. Finally, the representations of the three channels are integrated through the following equation:

H_{fin}=σ(Σ_{i∈{1,2,3}}α_{1i}H_i)
where σ represents the activation function. Through this way, the final representation is generated by performing a weighted summation of the three channels.

This channel importance-based multi-channel mixing method enables dynamically adjusting the importance of information provided by each channel, which enables more effective representation learning, particularly in graph with complex structures such as heterophilic edge graph.

FIG. 6 is a table showing dataset statistics for learning the unsupervised heterophilic edge graph analysis model, according to an embodiment of the present application.

Referring to FIG. 6, the following information is additionally provided for the experimental environment setting:
Comparison model: A comparison was made between GREET, a conventional graph representation learning model, and UDT, the unsupervised heterophilic edge graph analysis model proposed in the present application.
Implementation environment: PyTorch framework was used for model implementation. LogisticRegression was used for vertex classification. Experiments were performed using an NVIDIA GeForce RTX 2080 GPU.

FIG. 6 shows main characteristics for six different heterophilic edge graph datasets. The datasets included in the table include Texas, Cornell, Wisconsin, Chameleon, Squirrel, Actor. The following information is provided for each dataset:
Number of vertices: indicates the total number of nodes in the graph. Texas, Cornell, Wisconsin are relatively small-scale datasets, whereas Chameleon, Squirrel, Actor are large-scale.
Number of edges: indicates the total number of connections in the graph. This figure reflects the complexity of the dataset. The Squirrel dataset has the most edges at 216,933.
Number of classes: indicates the number of categories into which a node may be classified in each dataset. There are consistently five classes in all datasets.
Number of features: indicates a dimension of feature information provided for each node. Texas, Cornell, and Wisconsin each have 1,703 features, Chameleon has the largest number of features with 2,325, and Actor has the smallest number with 932.
Average degree of homophily of the edges: This value is an important indicator indicating the heterophily of the graph. A lower value means that the graph is more heterophilic. Texas is the most heterophilic with a value of 0.061, while Cornell is less heterophilic with a value of 0.298.

Experimental Method: The average accuracy and standard deviation over 10 runs are shown. This is to assess the stability and consistency of the model.

By using datasets with these various characteristics and establishing a systematic experimental environment, it is possible to comprehensively verify whether the model of the present application is applicable to various complex network structures in the real world.

FIG. 7 is a table showing a result of comparing node classification accuracy between the unsupervised heterophilic edge graph analysis model and an conventional model (GREET) on six heterophilic edge graph benchmark datasets, according to an embodiment of the present application.

Referring to FIG. 7, this table shows the performance of two models on six datasets: Texas, Cornell, Wisconsin, Chameleon, Squirrel, Actor. In each cell, the average accuracy and standard deviation are expressed as a percentage.

The main results are as follows:
Superiority of UDT: In 5 out of 6 datasets (Texas, Cornell, Wisconsin, Chameleon, Squirrel), UDT showed higher accuracy than GREET. This means that UDT consistently shows superior performance in various types of heterophilic edge graphs.
Performance enhancement: UDT showed a 1.42% performance enhancement over GREET on average. This represents a statistically significant improvement, thereby demonstrating the effectiveness of UDT.

Performance by dataset:

$$Texas : UDT ( 79.73 \pm 3.87 ) vs GREET ( 78.11 \pm 6.22 )$$

$$Cornell : UDT ( 71.62 \pm 5.95 ) vs GREET ( 69.3 \pm 8.24 )$$

$$Wisconsin : UDT ( 76.47 \pm 4.3 ) vs GREET ( 73.75 \pm 4.25 )$$

$$Chameleon : UDT ( 64.47 \pm 2.18 ) vs GREET ( 63.05 \pm 1.73 )$$

$$Squirrel : UDT ( 52.03 \pm 1.7 ) vs GREET ( 41.51 \pm 1.04 )$$

$$Actor : UDT ( 35.35 \pm 1.24 ) vs GREET ( 38.73 \pm 0.71 )$$

Consistency: UDT shows lower standard deviation than GREET in most datasets, providing more stable and consistent performance.
Notable: GREET showed higher performance in Actor dataset, but UDT was superior in all other datasets.

These results suggest that the UDT better captures the characteristics of the heterophilic edge graph, and effectively utilizes the feature of the node and the connection information of the original graph. In particular, consistent performance enhancement in datasets with varying sizes and characteristics demonstrates the generalizability and robustness of UDT.

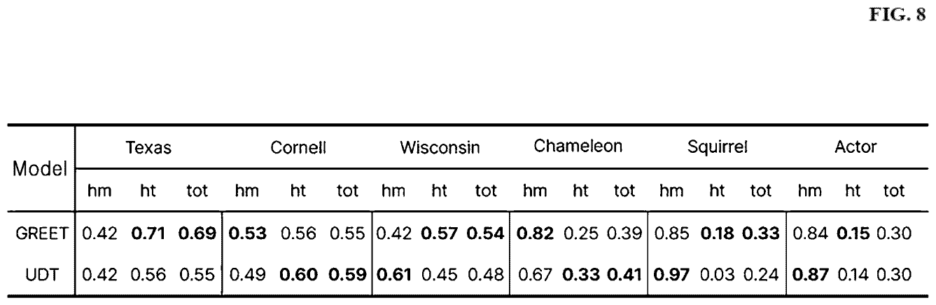

FIG. 8 is a table comparing edge property prediction accuracy and vertex classification accuracy according to the change in the number of positive samples, between the unsupervised heterophilic edge graph analysis model and the conventional model (GREET), according to an embodiment of the present application.

Referring to FIG. 8, homophily (hm), heterophily (ht), and total (tot) edge prediction accuracy are shown for each dataset (Texas, Cornell, Wisconsin, Chameleon, Squirrel, Actor). The main results and analysis are as follows:
Comparison of edge property prediction accuracy: In the Texas, Wisconsin, Squirrel datasets, the edge property prediction accuracy of GREET was higher than that of UDT; however, UDT exhibited superior vertex classification accuracy. In the Cornell and Chameleon datasets, the edge property prediction accuracy of UDT was higher than that of GREET, and the vertex classification accuracy was also better for UDT. In the Actor dataset, the edge property prediction accuracy of GREET and UDT was the same, but the vertex classification accuracy was slightly higher for GREET.
Robustness of UDT: UDT showed higher vertex classification accuracy in most datasets even when edge property prediction accuracy was lower than GREET. This suggests that the UDT may further learn the feature information and the connection information of the original graph, respectively, thereby compensating for inaccuracies in edge property prediction.

Homophily and Heterophily Prediction: Homophily (hm) predictions tended to be more accurate than heterophily (ht) predictions for both UDT and GREET in most datasets. Exceptionally, in the Wisconsin dataset, the heterophilic prediction of GREET was more accurate, while the homophilic prediction of UDT was still more accurate.
Overall performance: UDT has been shown to be relatively less sensitive to edge property prediction accuracy. It is interpreted that this is because the UDT comprehensively utilizes various information through its multi-channel structure.
Characteristics by dataset: UDT in the Squirrel dataset showed very high accuracy (0.97) in homophily prediction, but very low heterophily prediction (0.03). In the Chameleon dataset, the homophily prediction was significantly better than the heterophily prediction for both GREET and UDT.

These results show that UDT may achieve better performance in the vertex classification task, while showing comparable performance to GREET in edge property prediction. In particular, UDT has shown the ability to effectively utilize feature information and connection information of the original graph to maintain or enhance vertex classification accuracy even in situations where edge property prediction accuracy is low. This suggests that the multi-channel structure of UDT may more effectively capture and utilize the complex characteristics of heterophilic edge graph.

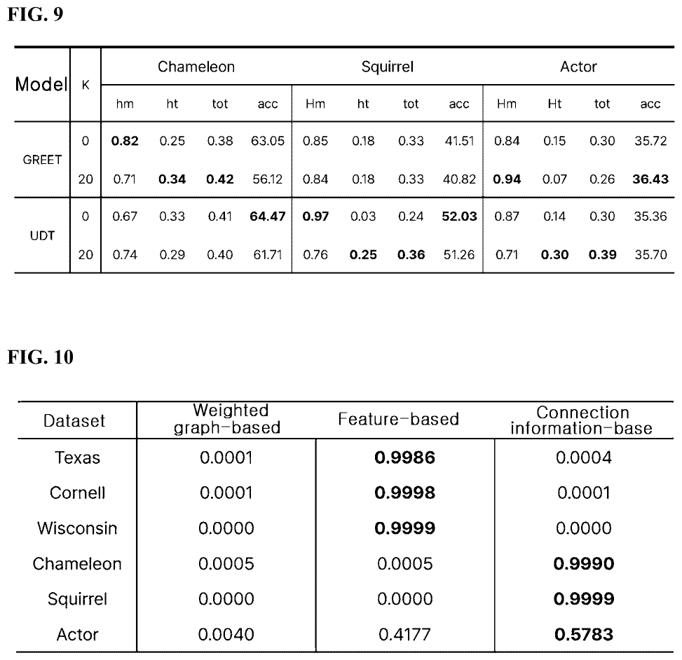

FIG. 9 is a table showing vertex classification accuracy result of the unsupervised heterophilic edge graph analysis model in consideration of channel importance, according to an embodiment of the present application.

Referring to FIG. 9, this table shows the results for the Chameleon, Squirrel, Actor datasets, showing the performance when the number of positive samples (K) is 0 and 20 for each model. The main analysis results are as follows:
Impact of the number of positive samples: For GREET, the homophilic edge prediction accuracy (hm) and vertex classification accuracy (acc) tended to change together as the number of positive samples increased in all three datasets. For UDT, no clear correlation between homophilic edge prediction accuracy and vertex classification accuracy was observed.
Characteristics by dataset: Squirrel showed only a 1% decrease in vertex classification accuracy despite a 21% decrease in edge prediction accuracy of UDT. In Chameleon and Actor, the vertex classification accuracy is enhanced even when the homophilic edge prediction accuracy is decreased.
Comparison between models: In Chameleon, GREET showed a 7% decrease in vertex classification accuracy as the number of positive samples increased, while UDT showed only a 2.8% decrease. In Squirrel, UDT showed higher vertex classification accuracy than GREET when K=O, and maintained higher performance even when K=20. In Actor, UDT showed lower vertex classification accuracy than GREET when K=0, but achieved almost equivalent performance when K=20.
Strength of UDT: UDT has been shown to be less sensitive to changes in edge property prediction accuracy. By further learning the feature information and the connection information of the original graph, it is possible to maintain or enhance vertex classification accuracy even in cases where the edge property prediction accuracy decreased.
Stability of the model: UDT exhibited less variation in vertex classification accuracy than GREET in response to changes in the number of positive samples. This suggests that UDT provides more stable performance.

These results show that the UDT further learns the feature information and the connection information of the original graph, respectively, and integrates them with the weighted graph-based representation, so as to avoid a sharp drop in the vertex classification accuracy due to a change in the number of positive samples. This suggests that UDT may provide more robust and consistent performance in datasets with a variety of graph structures and characteristics.

FIG. 10 is a table showing importance results of each representation based on a weighted graph-based representation of the unsupervised heterophilic edge graph analysis model, according to an embodiment of the present application.

Referring to FIG. 10, importance scores of three channels (weighted graph-based, feature-based, connection information-based) are shown for six heterophilic edge graph benchmark datasets (Texas, Cornell, Wisconsin, Chameleon, Squirrel, Actor). The analysis of the results shown in FIG. 10 confirms the following key features:
Channel importance distribution by dataset: In these three datasets—Texas, Cornell, Wisconsin, the feature-based channel exhibits overwhelmingly high importance (0.99860.9999). On the other hand, the importance of the weighted graph-based channel and connection information-based channel is very low (0.00000.0004). In these two datasets—Chameleon, Squirrel, the connection-based channel exhibits the highest importance (0.9990-0.9999). The importance of the other two channels is very low or negligible. In this dataset—Actor, three channels have relatively evenly distributed importance. The importance scores are distributed such that the connection information-based channel has the highest score (0.5783), followed by the feature-based channel (0.4177) and the weighted graph-based channel (0.0040), in that order.
Adaptability of UDT-A: The UDT-A model shows the ability to dynamically adjust the importance of each channel according to the characteristics of the dataset. This suggests that the model may effectively adapt to datasets with a variety of graph structures and characteristics.
Relationship between dataset characteristics and channel importance: In small-scale datasets such as Texas, Cornell, Wisconsin, feature information of the node plays a most important role. In a large-scale dataset such as Chameleon, Squirrel, structural information (connection information) of the graph plays a more important role. In the case of the Actor dataset, the feature information and the structural information have a similar level of importance, which reflects the complex characteristics of this dataset.
Flexibility of the model: UDT-A tends to enhance vertex classification accuracy even when the number of positive samples is zero or very small. This indicates that the model may flexibly adjust the importance of each channel according to the dataset by grasping the nature of the dataset and giving high weight to the feature information.

These results show that the UDT-A model may effectively adapt to heterophilic edge graphs with various characteristics, and adopt an optimal representation learning strategy tailored to the unique characteristics of each dataset. This suggests that the model of the present application may be usefully applied to various complex network analyses in the real world.

Such the unsupervised heterophilic edge graph analysis model and an analysis method using the same may be implemented as an application or in the form of program instructions that may be executed through various computer components, and may be recorded on a computer-readable recording medium. The computer-readable recording medium may include program instructions, data files, data structures, and the like, alone or in combination.

The program instructions recorded on the computer-readable recording medium may be those specially designed and configured for the present application, and may also be those known and usable by those skilled in the art in the field of computer software.

Examples of the computer-readable recording medium include magnetic media such as hard disk, floppy disk, and magnetic tape, optical recording media such as CD-ROM and DVD, magneto-optical media such as a floptical disk, and hardware devices specially configured to store and perform program instructions such as ROM, RAM, and flash memory.

Examples of program instructions include machine language codes, such as those made by a compiler, as well as high-level language codes that may be executed by a computer using an interpreter or the like. The hardware device may be configured to operate as one or more software modules to perform the processing according to the present application, and vice versa.

While the foregoing has been described with reference to embodiments, it will be understood by those skilled in the art that various modifications and alterations may be made to the present application without departing from the spirit and scope of the present application as set forth in the following claims.

### STATEMENT REGARDING PRIOR DISCLOSURES BY THE INVENTOR OR A JOINT INVENTOR

The inventors of the present application have made a related disclosure in CHOI, Seok Hwi and HWANG, Heasoo, “Unsupervised Heterophilous Graph Analysis Method with Edge Discrimination and Multi-Channel Mixing” Korea Software Congress 2023, published on Dec. 20, 2023. This related disclosure was made one year or less before the effective filing date (Sep. 26, 2024) of the present application. The inventors of the present application are the same as those of the related disclosure. Accordingly, the related disclosure is disqualified as prior art under 35 USC 102(b)(1)(A) against the present application. See 35 USC 102(b)(1)(A).

What is claimed is:

1. An unsupervised heterophilic edge graph analysis model, comprising:
an input unit configured to receive feature information and connection information for nodes in a heterophilic edge graph;
an edge discriminator configured to calculate a homophily weight and a heterophily weight for each edge of the graph;
a multi-channel encoder comprising: a first channel configured to process the feature information, a second channel configured to process the connection information, and a third channel configured to generate and process a weighted graph using the homophily weight and the heterophily weight;
an output unit configured to output a representation vector for each node generated from the multi-channel encoder; and
a classification unit configured to classify nodes of the graph using the output representation vectors.

2. The unsupervised heterophilic edge graph analysis model of claim 1, wherein the multi-channel encoder further comprises: a combining unit configured to generate a final representation vector by combining intermediate representation vectors respectively generated from the first channel, the second channel, and the third channel.

3. The unsupervised heterophilic edge graph analysis model of claim 2, wherein the combining unit combines the intermediate representation vectors through linear combination using a weight matrix.

4. The unsupervised heterophilic edge graph analysis model of claim 1, further comprising:
a contrastive learning unit configured to perform contrastive learning on the generated representation vectors.

5. An unsupervised heterophilic edge graph analysis method, comprising:
receiving feature information and connection information for nodes in a heterophilic edge graph;
calculating a homophily weight and a heterophily weight for each edge of the graph by using an edge discriminator;
generating a representation vector for each node by using a multi-channel encoder comprising a first channel configured to process the feature information, a second channel configured to process the connection information, and a third channel configured to generate and process a weighted graph by using the homophily weight and the heterophily weight;
outputting the generated representation vectors; and
classifying nodes of the graph by using the output representation vectors.

6. The unsupervised heterophilic edge graph analysis method of claim 5, further comprising:
combining intermediate representation vectors respectively generated from the first channel, the second channel, and the third channel, to generate a final representation vector.

7. The unsupervised heterophilic edge graph analysis method of claim 6, wherein the combining of the intermediate representation vectors is performed through linear combination using a weight matrix.

8. The unsupervised heterophilic edge graph analysis method of claim 5, further comprising:
performing contrastive learning on the generated representation vectors.

9. The unsupervised heterophilic edge graph analysis method of claim 8, wherein the contrastive learning is performed such that representation vectors of the same node from different perspectives become similar.

10. A computer-readable recording medium having recorded thereon a program for causing a computer to execute the method of the claim 5.
